(19) United States
(12) Patent Application Publication
(10) Pub. No.: US 2016/0253382 A1
(43) Pub. Date: Sep. 1, 2016

(54) SYSTEM AND METHOD FOR IMPROVING A QUERY RESPONSE RATE BY MANAGING A COLUMN-BASED STORE IN A ROW-BASED DATABASE

(71) Applicant: ORI SOFTWARE DEVELOPMENT LTD., Ramat Gan (IL)

(72) Inventor: Moshe SHADMON, Palo Alto, CA (US)

(73) Assignee: ORI SOFTWARE DEVELOPMENT LTD., Ramat Gan (IL)

(21) Appl. No.: 15/055,201

(22) Filed: Feb. 26, 2016

Related U.S. Application Data
(60) Provisional application No. 62/176,694, filed on Feb. 26, 2015.

(51) Int. Cl. G06F 17/30

(52) U.S. Cl. CPC G06F 17/30463

(57) ABSTRACT

A system including a shared disk database cluster including one or more database nodes, and at least two storage nodes including a first storage node or nodes with data organized in a row-based format, and a second storage node or nodes with data organized in a column-based format. A method for efficiently searching utilizing a shared disk database cluster including one or more database nodes, and at least two storage nodes including a first storage node or nodes with data organized in a row-based format, and a second storage node or nodes with data organized in a column-based format.

### CROSS-REFERENCE TO RELATED APPLICATION

This nonprovisional application claims the benefit of U.S. Provisional Application No. 62/176,694 filed Feb. 2, 2015. The disclosure of the provisional application is hereby incorporated by reference herein in its entirety.

### BACKGROUND

1. Technical Field

The present disclosure relates to storage of data in databases, and in particular, a database management system and method for efficiently managing a column-based store in a row-based database, and handling queries in an efficient manner. The database system and management system of the present disclosure may efficiently store database information in columnar format (e.g., to handle analytical processing) and a row format (e.g., to handle transaction processing, which columnar format may not be good for). The database system and method provide for both row-based organization and column-based organization of data in the same database (DBMS). More specifically, storing multiple copies of the data in different formats may be useful for improving the query response rate of transactional databases.

2. Related Art

Database Management Systems (DBMS) systems and methods are generally known. Conventional DBMS applications may manage large data sets in a DBMS by organizing the data into rows or columns. This organization may be used to provide the data efficiently in a logical structure that is meaningful to the user or the application. With a relational database, this logical structure may be a table. In row-based or row-oriented DBMS, relational database, this logical structure may be a table. In row-based or row-oriented DBMS, every row may represent an entry in the table with values (real or null values) for each column. For example, a table of a row-based DBMS may represent one or more companies with each row representing a single company. Columns in the row-based DBMS might represent the different attributes (referred to as columns), such as, a company name, company address information, an indication of whether the company is publicly held, a Value-Added Tax (VAT) identification number (ID), etc. In another example, a row-based DBMS table may represent an association of employees with departments with each row associating one employee with one department. The physical implementation of a row-based DBMS organization may physically group all of the column values of each entry (row) of the table into a string of bytes. Multiple rows may then be organized in disk-based blocks with each block being stored in a file. When a row is retrieved in the row-based DBMS, all the column values of the entry may be available.

In contrast, a column-based or column-oriented DBMS is a DBMS that may group the data by columns such that all the values (of all the entries in the table) of a particular column and an identification of the logical entry of the table are grouped together. In other words, the organization of the data in a column-based DBMS may include a structure that efficiently represents the different column values for each entry in the logical table that may be used by one or more users of a connected terminal device or devices. The organization is done such that the logical relational table view can be constructed even though the data (the different column values) of a particular entry in the table (such as a particular company information in a table representing different companies) is distributed among different physical structures. For example, the physical organization of the column-based DBMS may include multiple files each containing the information of a particular column from the company's table with a unique identifier of the company (e.g., company ID). For example, a particular file may represent a zip code column, and may include an entry for every company where the zip code is coupled with a company identifier. Therefore, in this example, upon receipt of a query (user search command) for all of the companies at a particular zip code location (e.g., Zip Code=94306), the column-oriented DBMS may trigger a scan of the data in the files separately storing the zip codes, to determine whether any of the entries of the column-oriented DBMS match the particular zip code location, and if a match is determined, transmit the company identifier of one or more matching entries to the requesting application. Obviously, scanning a smaller file is more efficient than scanning a larger file, therefore scanning a file that includes the zip codes (and company identifiers) only is more efficient than scanning a row-based structure that includes all the information (including the zip codes) of all the companies.

Conventionally, row-based storage may support transactional queries, such as, On-Line Transaction Processing (OLTP), which typically uses a row-based format. However, column-based/oriented storage models are generally used to support Analytical Processing (OLAP). However, in many cases, a columnar database is not capable of managing the data in transactional mode (e.g., OLTP) while ensuring the ACID properties of the database are maintained.

Thus, to solve the above-mentioned deficiencies of the conventional DBMS systems and methods, the disclosed systems and methods provide in an exemplary embodiment a DBMS system that allows both row-based organization and column-based organization of the data in the same database (DBMS). The disclosure further provides for a simply way to allow for a row-based database to maintain and manage a columnar organization of the data while maintaining the transactional properties and ACID compliance when a database maintains a columnar organization of the data.

### SUMMARY

The present disclosure describes a method where at least one copy of the data is stored in a row format and at least one copy (second copy) of the data is stored in columnar format. Therefore, each copy of the data organizes the data in a different way and each copy of the data is used to satisfy a different type of query. The row format is used to satisfy queries when row based lookups are more efficient (than column based lookups) and the column format is used when column based lookups are more efficient (than row based lookups). In addition, as will be detailed below, some queries are best satisfied by both—the query can be broken into several sub queries whereas some are satisfied by row based lookups and some are satisfied by column based lookups. Conventional database management systems and methods did not provide systems and methods for handling a query request based on a row-based format or a column-based format.

### BRIEF DESCRIPTION OF THE DRAWINGS

Exemplary embodiments will be described with reference to the following drawings.

FIG. 1 shows a Shared Disk DBMS system 100 (a clustered, shared disk DBMS) in accordance with an exemplary embodiment of the present disclosure. Shared disk DBMS 100 may include a database tier 101, which includes multiple DBMS nodes 101A-101C. The nodes 101A-101C may each comprise a processing element (e.g., a central processing unit (CPU), a hardware processor, a cloud-based processor) and a memory (e.g., hard disk memory, flash array). The nodes 101A-101C may be in a cluster, configured to be connected to each other, and capable of transmitting and receiving information over a network 110 (as shown by the connecting lines of the network 110 in FIG. 1). The system 100 may include two database storage tiers 102 and 103: storage tier 102 having multiple storage nodes 102A-102D, and storage tier 103 having multiple storage nodes 103A-103D. The system may further include database nodes 101A-101C that may also be connected and storage nodes (102A-102D and 103A-103D) may be connected by network 110 and managed by a network-connected distributed lock manager (DLM) 104.

FIG. 2 shows an exemplary column-based relational table 200. The relational table 200 is a Companies Table with information on different companies, although other embodiments may be utilized with relational table 200. As shown in FIG. 2, in the exemplary relational table 200, every entry (such as entry 210) may contain information on a particular company (for the company of entry 210, the company ID is 12580 and the company name is GTR). Columns 201-207 of the relational table 200 describe the type of information that may be represented by the table, such as, a unique company identifier (ID) in column 201, the company name in column 202, address information (e.g., the address information of the headquarters of the company) including a street address (column 203), a city (column 204), a state (column 205), and a zip code (206), and a phone number in column 207. When the customer looks at the data in FIG. 2 it is a readable manner. The table of FIG. 2 is an exemplary embodiment of the logical view of the data and it represents how the users see (and consider) the data (e.g., users of a terminal device 108, who can view the data on a display screen of the terminal device 108, the terminal device being connected to proxy 105 that interacts with one or more of the DBMS nodes 101A-101C).

FIG. 3 shows an exemplary row-based organization of the data presented in the table 200. Every row in the structure 300 includes all the column values of every entry in the relational table 200. For example, the row entry 310 may include all the values of the relational entry represented by 210 in FIG. 2. However, the row-based information can include additional information, which is not included in the relational representation 200 such as column 308 that maintains a flag representing if the row was deleted by a user.

FIG. 4 shows a column organization of the data of the relational table 200. All of the data values for each type of column are organized as a single list and stored as a separate file. For example, all of the companies' names are grouped together (each with its associated company ID).

### DETAILED DESCRIPTION

### Glossary of Terms

For clarity of explanation, there follows a glossary of terms used throughout the description and claims. Some of the terms are conventional and others have been coined.

A Database is an organized collection of data.

Database Management System or Systems (DBMS) are computer software applications that interact with a user, other applications and the dataset itself to capture and/or analyze data. For example, database and DBMS are explained by: (i) Hector Garcia-Molina, Jeffrey a Ullman, and Jennifer Widom in “Database Systems: The Complete Book, Second Edition,” (ii) C. J. Date in “An Introduction To Database Systems, Volume 1, Fourth Edition,” and (iii) Wikipedia's online definition for “Database” and “Database Management.”

A Database Node or Database Server is a virtual or physical machine. The database node or server may runlexecute DBMS software. In the following description, the terms node and server are used interchangeably to refer to a database node or server. Non-limiting examples of DBMS software are: (i) Oracle database software, (ii) IBM DB2 software, and MySQL software. A database node may provide management of data such that users are provided with the methods and tools (among others) to update and query the data. For example, a database node, executing database software (e.g., Oracle database software) such that data manipulation requests (e.g., Insert, Update, Delete and Select) issued by users may trigger processes that update and query data. Further, a database node may have a local cache. The local cache may be used for efficient processing of frequently used data. A database node on a physical or virtual machine may provide database services. Users or applications may send requests to the database node to manipulate data. As another example, a physical or virtual machine (database node) executing an instance of MySQL server software may have a local cache. The local cache may be a memory area in the database node that maintains copies of frequently used data. Examples of frequently used data are particular rows of a table or particular blocks that contain data (or rows) that are frequently used.

A Storage Node is a virtual or physical machine executing software to manage input/output operations (IOs, I/O or I/O operations). A storage node may receive one or more requests to manage data via TO requests (e.g., requests for reads or writes of data), execute a request, and, if needed, reply to satisfy the request. The storage node may, for example, write the data to some form of persistent storage such as a disk or solid state. Each storage node may have a local cache, which may be used for efficient processing of frequently used data. However, a storage node may satisfy many other requests such as, requests to scan files or portion of files and search for data that satisfy particular conditions.

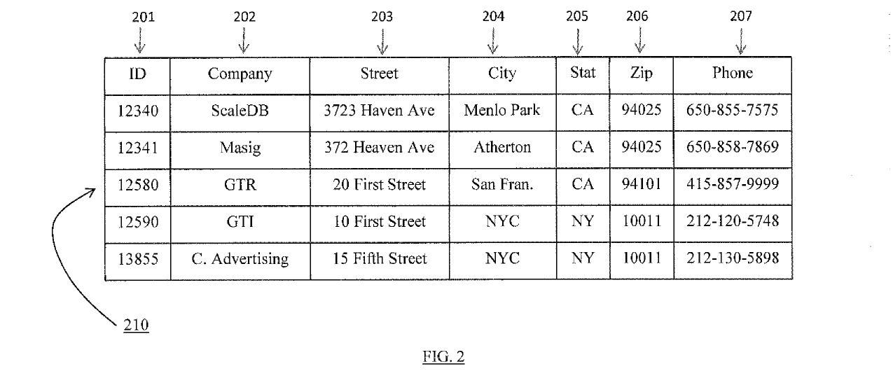

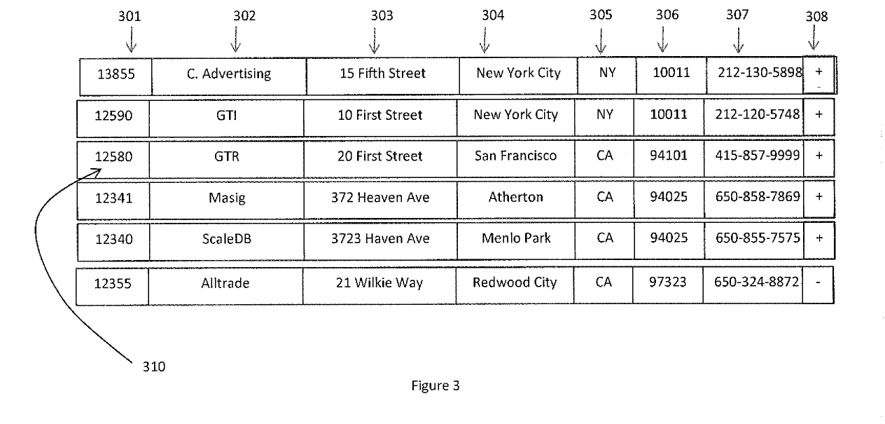

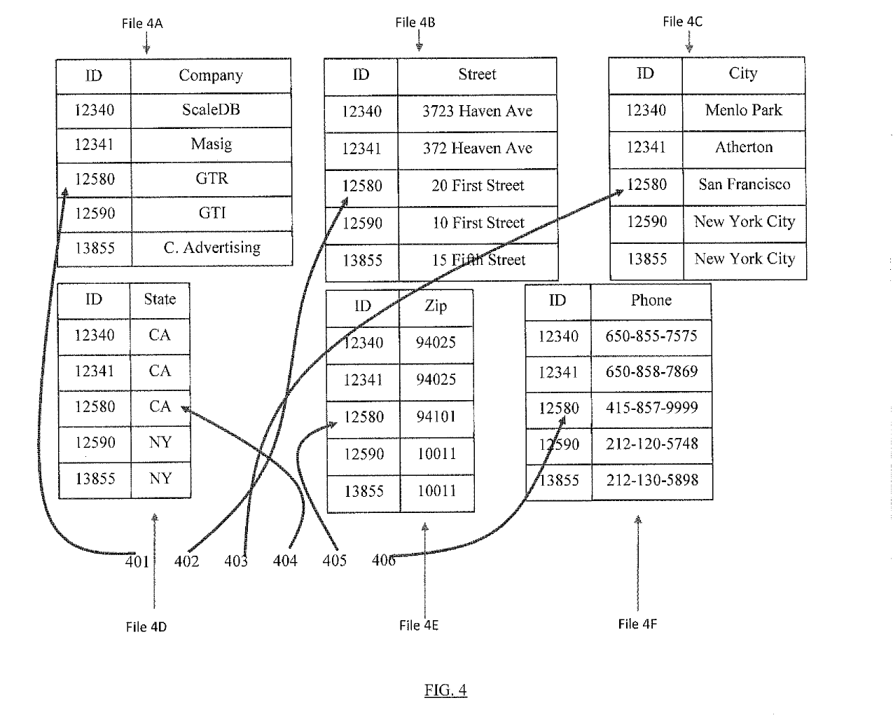

The storage nodes may further map a row-based structure to a columnar structure and vice versa. For example, when a new row is added to a particular storage node, such as row 310 of FIG. 3, the storage nodes may retrieve the different column values from the row 310 and update a columnar structure, in this particular example, the columnar structure is the different column based organizations (files 4A-4F) of FIG. 4. More specifically, row 310 of FIG. 4 can be used to update attribute values 401-406 of FIG. 4 (each with the respective values of a particular column and corresponding company IDs). Alternatively, to satisfy a query that is interested in entry 210 of FIG. 2, the database may assemble the column values 210-207 of row 210 of FIG. 2 from the entries 401-406 of FIG. 4.

An example of a storage node is a physical or virtual machine that provides data storage services. A storage node may satisfy I/O requests of database nodes. The transfer of the requests (between the storage node and database nodes) and the reply to the requests may be performed over a network.

A Cluster (or a Database Cluster or a Clustered Database) may be formed of multiple database nodes that provide processing or management of data. The nodes of the cluster may be connected via a network and provide management of Shared Data.

Shared Data is data that may be accessible to multiple database nodes. For example, in a Shared Data architecture, if data is updated or added by a particular database node, it may also be available to different database nodes (in the cluster) for update and query. A database cluster having a shared data architecture may provide a consistent view of the data (i.e., the database cluster is capable of providing the ACID properties (atomicity, consistency, isolation and durability) with the shared data. In the present disclosure, the terms Shared Data and Shared Disk are used interchangeably.

A Relational Database is a database that conforms to a relational model theory. The type of software used in a relational database may be called a relational database management system (RDBMS) or RDBMS software. In a relational database, data may be logically partitioned or assigned into tables and may be organized as rows within the tables. However, the physical implementations of the RDBMS may be different. As one example, rows may be physically stored within blocks of files. Some of the examples below use the logical organization of rows within tables or use some physical organization such as rows within blocks. However, the processes of the disclosure are not bound to a particular logical or physical organization. For example, as another organization scheme, the data may be organized by columns. Some of the resources of the database may be indices, which may be organized in blocks of files, but are not part of the relational model theory, and that are used to organize the data by key values, determine uniqueness of the key values, and locate data.

Data is information that may be stored and/or manipulated.

An Attribute may be a feature or characteristic of data. For example, an attribute may be represented as columns in a relational database. For example, a record representing a person may have an attribute “age” that is stored in a column representing an age of a person. Each column of a relational database may represent an attribute.

A Column, in the relational database context, may represent attributes for particular rows in a relation. For example, a single row might contain a complete mailing address entry. The mailing address row may have four columns (attributes): street address, city, state, and zip code.

A Hidden Column may be a column in a row that is not visible to a user and/or a user application. A hidden column is used by a database system (e.g., DBMS, RDBMS) for internal operations. For example, a hidden column may be a column that includes a link to a different row in the database. The link maintained in the hidden column may be part of a linked list that connects multiple rows in the database. Column 308 of FIG. 3 is an example of a hidden column as it is not represented in the relational representation of the data showed in the logical table of FIG. 2.

A Record may be a single entry in a database. A record may also be referred to as a tuple or row in a relational database. In a DBMS, a row is an entry in the relational table such as entry 210 of FIG. 2 and sometimes a physical representation of the data such as the row 310 of FIG. 3.

A Relation may be used to organize data into a table consisting of logical rows and columns. Each logical row may represent an entry in the table or relation. Each logical column may represent an attribute of the logical row entries. A relation is frequently referred to as a table.

A Relational Database may be a database that consists of one or more relations or tables.

A Database Administrator is a person (or persons) responsible for optimizing and maintaining a particular database or DBMS/RDBMS.

A Database Schema may be an organization of data in a database. In the relational database example, all new data that comes into the database may be required to be consistent with the schema. In this example, the database administrator may be required to change the schema (or reject the new data).

An Index may be additional information about a database that is used to reduce the time required to find specific data in a database or add data to the database. For example, an index may provide access to particular rows based on a particular column or columns.

A Query may be a search for information in a database.

A Range Query may be a search for a range of data values. For example, a range query may be a search for: “all employees aged 25 to 40.”

Input/Output operations (IOs or I/O or I/O operations) are operations that facilitate communication between an information processing system and a human or other physical device. For example, a read from a physical device (e.g., a fixed disk (hard drive)) is an input operation. IOs may take a significant amount of time compared to memory operations. For example, they may take hundreds and even thousands of times longer or more. In the context of the disclosure, I/O also refers to the process of retrieving data from storage nodes or updating data on the storage node (output operations) or other forms of manipulating data on the storage node. An I/O process may include one or more messages over the network between a database node and a storage node.

A Proxy may be a server (a computer system or an application) that acts as an intermediary for requests from clients seeking resources from other servers. See Wikipedia online definition of “Proxy Server.”

A Block Read may be a read on a fixed sized chunk (a block) of information. A block read may be implied to be an I/O, if the block is not in memory.

A Query Optimizer may be a component of a DBMS that attempts to determine the most efficient way to execute a given query by considering the possible query plans. See Wikipedia online definition of “Query Optimizer.” In the context of the present disclosure the Query Optimizer may also decide if a particular query is to be satisfied from the row-based organization (such as the organization of FIG. 3) or a columnar based organization (such as the organization of FIG. 4).

A Query Plan (or query execution plan) is an ordered set of steps that may be used to access data in a DBMS. See Wikipedia online definition of “Query Plan.”

A Lock Manager may be a manager that: (i) receives lock requests from different processes or threads, (ii) analyzes the lock requests, and (iii) manages the lock requests so that the integrity of data is maintained. For example, a lock manager may issue particular locks, without explicit lock requests, when the Lock Manager determines that a particular process or a particular node is interested in the particular lock.

A Local Lock Manager (LLM) is a lock manager that analyzes and manages the lock requests of different threads (or processes) by utilizing a shared memory space. An LLM and the requesting threads (or processes) may exist within the same node. For more information, a discussion on locking is available by Hector Garcia-Molina, Jeffrey D. Ullman, Jennifer Widom in “Database Systems: The Complete Book, Second Edition,” at “Chapter 18, Concurrency Control, Section 18.4: Locking Systems with Several Lock Modes,” pages 905-913.

A Distributed Lock Manager (DLM) may be a lock manager that analyzes and manages lock requests of different threads (or processes) of different nodes. A DLM and the different threads may communicate by sending messages over a network. The DLM may manage a cluster of nodes.

The management by a LLM and/or a DLM (together with other processes) maintains the integrity of the data. The LLM and/or DLM may maintain compliance of the database to the ACID set of rules.

ACID (atomicity, consistency, isolation, durability) Properties or Rules are a set of properties or rules that guarantee that database transactions are processed reliably. See Wikipedia online definition of “ACID” (in the context of computer science).

A DLM may operate by monitoring processes in different nodes. The DLM, in this example: (i) analyzes lock requests that are issued from different processes (or nodes), (ii) provides grants to non-conflicting requests (e.g., multiple requests to read the same data at the same time), and (iii) sets an order among conflicting requests. For example, a write lock may be provided to process A by a DLM, and, thus, a grant (for a read or write request) for process B may be delayed by the DLM until the lock of process A is released.

SQL or Structured Query Language is a programming language designed for managing data in an RDBMS. SQL was one of the first commercial languages for Edgar F. Codd's relational model, as described in: (i) his influential 1970 paper, “A Relational Model of Data for Large Shared Data Banks,” and (ii) Wikipedia's online definition for “SQL.” Eventually, SQL became the most widely used database language. SQL is used also as a Data Manipulation Language (DML).

A Data Manipulation Language (DML) may be a family of syntax elements used in a programming language (e.g., SQL) used for inserting, deleting, selecting and updating data in a database. See Wikipedia online definition of “Data Manipulation Language.”

Data Definition Language (DDL), such as Create Table and Drop Table, may be used in SQL to declare and remove tables. See Wikipedia online definition of “DDL.”

A Database Engine or Storage Engine may be the underlying software component that a DBMS uses to create, read, update and/or delete (CRUD) data from a database. Most DBMS include their own Application Programming Interface (API) that allows a user to interact with their underlying database or storage engine without going through a user interface of the DBMS.

Many of the modem DBMS support multiple database engines within the same database. For example, MySQL may support InnoDB, MyISAM, and/or other storage engines.

A B-tree is a tree structure that can be used as an index in a database. It may be useful for exact match and range queries. B-trees may frequently require multiple block reads to access a single record. More information on B-trees can be found on pages 473-479 of “The Art of Computer Programming,” Volume 3, by Donald Knuth (.RTM. 1973, Addison-Wesley). A B-tree or one of its variants is widely used to index data in DBMS.

A Hash Table or Hash Index is a structure that can be used as an index in a database. A hash table/index may be useful for exact match queries, but it may not be useful for range queries. Hash tables generally require one block read to access a single record. More information on hash tables may be found on, for example, pages 473-479 of “The Art of Computer Programming,” Volume 3, by Donald Knuth (.RTM. 1973, Addison-Wesley).

A Linked List may be a data structure linking or connecting a group of objects. For example, a process may consider an object of a linked list to be able to identify the next object on the linked list using a reference (a link) to a next object in the sequence. In this example, given the first object, using the linked list, all objects of the list can be identified.

A Unique Key may be a column or columns that are declared to uniquely identify a row or entry in a table. For example, in a customer table containing customer information, a column representing a customer ID may be declared as a unique key and the database will enforce a single row instance for every key value. Most database systems maintain an index that efficiently locates the row by the unique key. One of the unique keys may be designated as the primary key.

A Non-Unique Key may be a column or columns that are declared to identify a row or rows in a table, but without a requirement of uniqueness. Therefore, multiple rows may share the same value. For example, in a customer table that contains customer's information, the column representing the customer type may be declared as a non-unique key and the database may contain multiple rows with the same value. Most database systems maintain an index that may efficiently locate rows by a non-unique key value.

A Lock Taken (process) is a process where a lock over a resource is taken. A lock taken may be a result of a process determining that there is no conflicting usage of the resource. The lock may be taken using an asynchronous message (e.g., the asynchronous lock taken message detailed in U.S. Pat. No. 8,924,370 (Shadmon)).

Contention refers to a state of dependency between two or more processes. For example, a state of contention may result in a process being set in a wait state. The wait state may be resolved when a different process completes an operation or, in some cases, the wait state is resolved when the process in wait determines to terminate the operation.

A Process is an execution of computer instructions to execute a particular task. In a particular example, a process is executed by a particular thread.

### BRIEF DESCRIPTION OF THE EXEMPLERY EMBODIMENTS

In an exemplary database system and method, when data is stored in a DBMS, at least two copies (data sets) of the data may be written. The copies may be placed in two (2) separate physical data stores. One of the data sets may represent one copy of the data organized in a row-based format, and the second dataset may represent the second copy of the data organized in a columnar format. Queries are satisfied by using the data organization that would be more efficient. Efficiency is measured by the time needed to retrieve the rows or compute the values that are needed to satisfy the query. The decision to use the row-based organization or the column-based organization of the data may be done by a DBMS component such as the Query Optimizer.

### DETAILED DESCRIPTION OF THE EXEMPLERY EMBODIMENTS

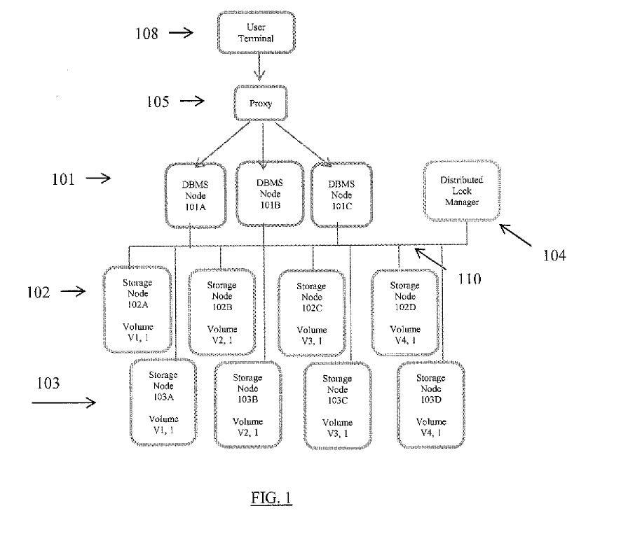

FIG. 1 shows a Shared Disk database management system (DBMS) 100 (a shared DBMS) in accordance with an exemplary embodiment of the present disclosure. Shared disk DBMS 100 may include a cluster of database and storage nodes, such as: (i) a database tier 101, which may include multiple DBMS nodes 101A-101C, and (ii) a storage tier 102, 103 which may include multiple storage nodes 102A-102D and 103A-103D. As shown in FIG. 1, the cluster may be managed as two (2) tiers—a database tier 101 and a storage tier (which may be composed of sub-tiers 102 and 103). FIG. 1 shows an example of three database nodes (101A-101C) and eight storage nodes (102A-103D). Each node may be a server including a processor (CPU) and memory. The nodes 101A-101C and the storage nodes 102A-103D in the cluster may be connected by network 104 to each other and connected to and managed by distributed lock manager (DLM) 103.

In the cluster of FIG. 1, a user may use a terminal 108 to issue queries to the database. In particular, the terminal 108 may include a processor, a memory, a display screen (e.g., Liquid Crystal Display Screen, Touchscreen) and a network communication unit. The terminal may be connected to the DBMS nodes 101A-101C via a networked proxy (such as proxy 105 of FIG. 1) whereas the proxy, upon receipt of a query/search request from terminal device 108, may send/forward the query request to one of the database nodes (101A, 101B or 101C) that process the query and return the query result back to the user via the proxy. However, the terminal may also be directly connected to the database nodes 101A-101C. The terminal 108 may be, for example, a cellphone, smartphone, personal digital assistant, laptop, tablet, computer. Although only one terminal 108 is shown, the DBMS system 100 may be configured to handle many terminal devices and users. The query may be transmitted to a cellphone tower and routed through the Internet (using an IP and Port) to the proxy 105 of FIG. 1. The proxy may deliver the query to a database node such as 101A that processes the data, returns the result to the proxy that routes the result back to the user terminal 108 using the Internet and the cell phone provider infrastructure. In the cluster of FIG. 1, a volume is a logical unit which is supported by one or more nodes. As shown in the example of FIG. 1, the data may be divided into volumes whereas each of the volumes is supported by 2 storage nodes. For example, with 4 volumes, and 2 storage nodes per volume, the data is divided into 4 parts such that every volume comprises one quarter (¼ or 25%) of the data. The data of each volume is kept twice, once on each node of the volume. In an embodiment with 2 nodes per volume, there are 2 copies of the data. In an embodiment with 3 storage nodes supporting each volume, there are 3 copies of the data. With reference to the embodiment of FIG. 1, the 4 storage nodes 102A-102D in the storage sub-tier 102 each manage a volume V1-V4 (respectively) with each volume V1-V4 equaling ¼ of the data. Each storage node 103A-103D in the storage sub-tier 103 each have copies of the data of volumes V1-V4, respectively. For example, as shown in FIG. 1, storage nodes 102A and 103A each contain one copy of the data managed by volume V1, storage nodes 102B and 103B each contain one copy of the data managed by volume V2, storage nodes 102C and 103C each contain one copy of the data managed by volume V3, storage nodes 102D and 103D each contain one copy of the data managed by volume V4. With each of the volumes V1-V4 comprising one quarter of the data, each of the tiers 102 and 103 of storage nodes contain duplicate copies of the data. Although each of the four volumes V1-V4 are used to house one quarter of the data each, different numbers of the volumes may be used, where each volume has an amount of data (approximately) equal to the amount of data divided by the number of volumes. If each volume is supported by more than one storage node, each volume has multiple copies of the data.

The Shared Disk DBMS system 100 may further include a Distributed Lock Manager (DLM) 104 that may synchronize the processes in the cluster. The database nodes, storage nodes and the DLM 104 may be connected by a network 110. This cluster can provide database functionality such as the functionality described in U.S. Pat. No. 8,924,370 (Shadmon). The DBMS nodes 101A-101C may be further connected to a proxy 105. The proxy 105 may receive DML requests from the applications or users (not shown), and partition these requests among the database nodes 101A-101C. In one exemplary embodiment, these requests are SQL statements such as Insert, Update, Delete and Select.

The cluster of FIG. 1 may manage shared data such that the data set is partitioned among the different volumes and every database node 101A-101C may update or query the entire data set. The DLM may resolve conflicts among processes of the cluster. For example, if different processes in different database nodes are interested in updating the same data at the same time, the DLM will evaluate lock requests and lock states to determine the process that is allowed to update. When a lock of an updater is released, the DLM will grant a lock to a next process. Each database node 101A-101C may further include a Local Lock Manager (LLM). When processes within the same node compete over resources, the LLM will synchronize the operations of the different processes.

The DLM 104 and LLM of each DBMS Node 101A-101C may operate such that different users querying the database cluster will receive a consistent view of the data regardless of the database node that processes the data. An advantage of managing the data by multiple database and storage nodes is that more resources (such as memory, CPU, disk drives) are available to support the user requests to manipulate the data.

In a particular example, the Shared Disk DBMS System 100 of FIG. 1 may manage a call center. In a call center example, the System 100 may manage several tables with one of the tables being an event table where each row represents a phone call. Therefore, each row in the event table may have the information regarding the phone call (e.g., phone number originating the call (source phone number), the phone number receiving the call (destination phone number), the starting time of the call, the duration of the call and additional information as needed by the call center). In addition, the row may contain a column that uniquely identifies the row such as an Event ID which may be designated as the primary key.

When a database node 101A-101D processes a query, and a key value is available, the node may use the index that supports the key to retrieve the rows that satisfy the query. However, if a key is not available, the node may scan the data table to find the row or rows that satisfy the query. For example, if the event table of the call center database is indexed by phone number, this index may be used to retrieve the rows that have originated by a particular phone number. However, if the query is to find all the rows with duration longer than 3 hours, and there is no index by duration, the database would issue a scan over the table rows to find the rows representing these calls. In the context of the present disclosure, the index-based lookup may be better served by a row-based organization of the data and the scan-based lookup (e.g., a scan to find the rows by the phone number) may be better served by the columnar organization.

As the DBMS System 100 may be managing many DML operations, multiple processes among the nodes 101A-101C in the cluster may be competing over many resources. In particular, adding data to the database creates contention between processes within the same node and of different nodes over database resources. For example, when an insert process adds a row to the event table, several indexes needs to be updated. As indexes are updated, the processes are competing over the locks which are required for the updates. To complete an update of a Btree index, the updating process may need to retrieve the non-leaf blocks of the index with read locks and update the leaf block with a write lock. If these locks are not compatible with existing locks over the needed resources, the updating process may need to wait for the grants. These locking processes consider the data as organized in rows.

One of the purposes of the present disclosure is to provide an efficient process that will allow supporting queries by row-based organizations and by column-based organization without changing the logic and processes used by the DBMS nodes 101A-101C.

When new data is added to a table in a database, the data may be stored on a physical file and some indexes may be updated. In a relational database, the data is organized in rows and the rows are assigned to a table. Each row in a table is logically partitioned into columns and the database administrator may define one or more keys over one or more columns. If the table is defined with keys, these keys are updated

Both the row-store and column-store database table formats offer various benefits. For example, the row-store format is usually used to maintain the ACID properties of the database. For example, indexes are used to enforce uniqueness of column values when these are required. The row-store table format is, however, relatively memory intensive for analytic queries (e.g., aggregation, join) as it scans a table vertically, pushing more information into memory than is necessary. Conversely, the column-store format offers flexibility in allowing complex manipulation of data involving table joins and aggregation, as well as relatively low memory consumption by allowing compression within data types across multiple entries by dictionary encoding. The column-store database format, however, typically does not allow ready manipulation of transactional and ACID compliance data as the row-store table.

In many instances, a row-based organization of the data is more effective to support queries that require a majority of the data record. One example is a query for the columns values of a single record using a primary key or a unique key lookup (e.g., retrieving the information of a particular customer, using the customer ID as a primary key). When the row is retrieved (by the key), all the columns values relating to the key are available. A column-based organization of the data is more efficient for column-based access such as a single column aggregation. Using a row-based organization for a column aggregation, a process of the database will need to retrieve all the rows in the table and sum the specific column value of each row. With large databases where the data is not in memory, the retrieval process may be using significant IO operations, which are expensive in terms of execution time. This is a type of query where a column-based organization may be more efficient as the particular column values that need to be summed are organized in a single file with much less extra information. The column-based file would be much smaller than the row-based file and therefore would be more efficient for this type of query as a smaller amount of data needs to be retrieved (read from disk) and pushed into memory (RAM).

In order to efficiently support column-based queries, U.S. Pat. No. 8,782,100 B2 (entitled: “Hybrid database table stored as both row and column store” suggests transferring data to and from a column store. The '100 patent explains: “Another technique which may be employed to enhance performance of a hybrid table, is to selectively move records to and from the column partitioned data store in order to control its size,” and “According to an access-based data movement policy, the hybrid table manager moves some portion of records on the row partition to the column partition, when the number of records on row partition exceeds a defined threshold. This access-based data movement can be based upon statistics maintained for accessed records, such that when a movement is triggered those records having a lower frequency of access are moved. Access statistics may be reset whenever a data movement is finished.” The method of the '100 patent maintains a single table representation of the data whereas some of the information is in a row-based organization while other information is in a column-based organization. In this method, a process is required to move and transform data from one organization to another.

According to the present disclosure, the data movement and background transformation to column organization is not needed. At any point in time, both, the row-based organization and the column-based organization are available for all the data that supports a table (or multiple tables). The process of the present disclosure is performed by using a storage setup similar to the storage setup of FIG. 1. With the storage setup of FIG. 1, when data is written, it may be written to a particular volume, and be duplicated in all of the storage nodes that support the volume (e.g., as discussed above storage nodes 102A-102D may contain identical data as storage nodes 103A-103D). When a particular volume of the data is written (e.g., V1), at least one of the storage nodes (e.g., storage node 102A) may be organized by rows, while at least one of the other nodes (e.g., storage node 103A) storing the identical copy of the volume may organize the data by columns. With the system and corresponding method of the present disclosure, at least one copy of the data is available in a columnar format and at least one copy of the data is available in a row format.

For example, a database node 101A may be adding new customers. The database node I 01A may decide to place the new customers in volume V3 of FIG. 1. Therefore, the list of customers may be sent via the network 110 to the storage nodes 102C and I 03C that support volume V3. Therefore, storage node 102C storing the data of volume V3 receives the list of customers and may set the customer information in a row-based format, while storage node 103C receives the same/identical list of customers and sets the customer information in a columnar-based format.

The process of managing the execution of a query is done on the database node receiving the query (such as DBMS node 101B of FIG. 1). The DBMS node may determine which organization is likely to satisfy the query in a more efficient way. If a row-based organization is more efficient, the query may use the organization of the storage nodes 102A-102D with the row-based organization, and if a column-based organization is considered to be more efficient, the query may use the organization on the storage nodes 103A-103D with the column-based organization. This decision may be done by the database optimizer.

With reference to FIG. 1, the storage nodes 102A-102D in sub-tier 102 have a row-based organization. A database node, such as DBMS node 101C may process a point lookup by a key, and may read the required data from the nodes 102A-102D of sub-tier 102. The same database node 101C, or a different database node, such as DBMS node 101B that needs to find the table entries with a particular column value {which may not be indexed), can use the column store (available on the storage nodes 103A-103D of storage sub-tier 103) to search within the file or files that contain the particular column. With this approach, the database logic in the database nodes 101A-101C may consider the row organization. This logic maintains the ACID properties of the database. When new data is written, the new data may be sent to nodes supporting one of the volumes. When the new data arrives at the row-based node of a particular volume, it is added to the row-organization. When the new data arrives to the column-based node of the particular volume it updates the column organization.

FIG. 2 demonstrates an example of a relational table 200 that contains information on different companies. Every entry in the table contains information on a particular company. The columns of the table include the company ID, which is the primary key, the company name, address, zip code state and phone number. The table of FIG. 2 is a logical representation of the data according to the relational model. It reflects the way the user described the data however it does not necessarily represent the physical organization of the data.

FIG. 3 shows a row-based organization 300 of the data of table 200. Every row of the row-based organization 300 includes all the column values of an entry in the relational table 200. However, the row-based organization 300 of FIG. 3 is not necessarily identical to the structure of table 200. The data in the row-based organization 300 may be organized differently (e.g., it may be compressed; it may include additional information which is not available to the user). For example, every row in FIG. 3 includes a flag showing a plus (+) sign if the row was not deleted and a minus (−) sign if the row was deleted. A row that was flagged with a minus sign is not presented in the table view of FIG. 2. For example, the company “Alltrade” of FIG. 3 is flagged as deleted and not presented in the table view of FIG. 2.

FIG. 4 shows a column-based organization 400 of the data of table 200. In the column-based organization 400, all the data values for each column (from all the entries of table 200) are grouped together. In particular File 4A of FIG. 4 groups company's names, file 4B groups Address information, file 4C groups City information, file 4D groups State information, file 4E groups Zip information and file 4F groups the phone information. In the example of FIG. 4, each grouping identifies the company ID next to the attribute value. In a different column based implementation, the grouping may be organized differently, for example, a zip code number followed by all the companies that share the same zip code. In that case file 4E would be organized as follows:
94025 (Zip Code) with companies 12340, 12341
94101 (Zip Code) with company 12580
1011 (Zip Code) with companies 12590, 13855

To support row based and columnar based searches, the following process is provided: When the database node writes new data, the database organizes the data in rows. In this scenario, the rows may be placed in blocks and each block may be sent to one of the volumes in the cluster. As each volume is supported by two storage nodes, each storage node of the volume may receive a copy of the data block. On the storage node that utilizes the row-based organization, the data block is added to the file that contains the rows of the table. See, e.g., FIG. 3. On the storage node that organizes the data by columns, the row representation is replaced by column representation. Each column of each new row is placed in the associated column-based file. This organization is demonstrated by FIG. 4.

For the insertion process, the database considers a row-based organization and does not need to manage the column representation. The mapping to column representation can be performed on the column-based (storage) node by assigning each new column to the column-based organization. This process allows managing the data at each DBMS node as a row-based data and only a copy of the data is stored as column-based organization. In the same manner, updates and deletes of rows update the column and row organizations.

With the architecture of FIG. 1, the query processing can be performed at each database node by retrieving the relevant data to the database node and processing the query at the database node. Alternatively, the query may be performed at the storage nodes by pushing a query from the database node to the storage nodes and processing the query on multiple storage nodes. The results of the processing may be returned by the storage node to the database node. The database node may aggregate the results from all storage nodes and return a unified reply to the application. The retrieval of the data to the database node can be performed from the row-based organization or from the columnar organization depending on which organization will be more efficient to retrieve the needed rows. In particular, if the query is pushed to be executed on the storage node, the database can determine which type of storage nodes would better satisfy the query and send the query to the more efficient type.

The following exemplifies the query process: A query to find all the companies with a particular zip code is sent by a particular application to a particular database node such as DBMS node 101A of FIG, 1. If the Zip code is not indexed, the database node 101A may retrieve the file 4E of FIG. 4 (from the columnar storage nodes in the storage sub-tier 103 of FIG. 1) and scan for the company IDs with the requested zip code/number. When the requested file having the zip code is found, the company ID is available and the company information may be retrieved from the row based storage (such as the storage nodes in the storage sub-tier 102 in FIG. 1). For example, searching for companies with the Zip Code 24025 would find companies 12340 and 12341 on the file 4E in FIG. 4. Then the database node may retrieve each company name or any other information from the row-based store by a point lookup using the company ID (e.g., which will bring ScaleDB and Masig from FIG. 2). Alternatively, the DBMS of node 101A may ship the query to the storage nodes with the column-based organization such as nodes in the storage sub-tier 103 of FIG. 1. In this example, each storage node has 1/4 of the data; each storage node searches the file 4E of FIG. 4 and only sends the IDs of the companies that share 94025 as their zip code. The DBMS node that receives the IDs can retrieve the company information using the IDs. As all the storage nodes may process the request in parallel, this approach provides a very high degree of parallelism.

At the same time, a different query, such as a query to find the address of a particular company with a particular id, could leverage the row-based organization. When the row with the particular company information is found (for example by using an index), the address is returned to the caller. The decision on which organization yields a more efficient search can be performed by a component of the database such as a Query Optimizer. The process of the Query Optimizer compares the time to satisfy a query (using different methods) to determine the most efficient way to satisfy the query. This determination may be based on information available to the Query Optimizer (e.g., statistics, previously recorded execution time of similar queries, and other information available to the Query Optimizer). This approach may allow for maintaining the columnar representation with no or with minimal changes to the database logic on the database nodes. A transactional database can therefore process data without the need to consider the column-based organization. Only when queries are executed, the database may direct a query to use a columnar representation. This approach allows the performance benefits of both—row-based and column-based stores within the database. As the database processes data with the row-based logic, transactional and ACID properties are maintained without the need to consider the columnar representation.

What is claimed is:

1. A system comprising:
a shared disk database cluster comprising:
one or more database nodes; and
at least two storage nodes including a first storage node or nodes with data organized in a row-based format, and a second storage node or nodes with data organized in a column-based formant, wherein
each of the storage nodes comprise a memory; and
each of the one or more database nodes comprise a processor configured to:
when a data write operation is received, write a copy of the data to each of the first storage node(s) and the second storage node(s); and
when a data search request is received:
(i) determine whether the first storage node(s) or the second storage node(s) would be more efficient in producing a result for the received data search request;
(ii) transmit the data search request to the first storage node(s) when the first storage node(s) is determined to be more efficient for the request, and to the second storage node(s) when the second storage node(s) is determined to be more efficient for the request; and
(iii) receive the results of the query from the storage node(s) that is determined to be more efficient.

2. A method for a shared disk database cluster comprising one or more database nodes and at least two storage nodes including a first storage node or nodes with data organized in a row-based format, and a second storage node or nodes with data organized in a column-based formant, the method comprising:
when a data write operation is received by a processor of one of the database nodes, writing a copy of the data to each of the first storage node(s) and the second storage node(s),
when a data search request is received by the processor: (i) determining whether the first storage node(s) or the second storage node(s) would be more efficient in producing a result for the received data search request; and (ii) transmitting the data search request to the first storage node(s) when the first storage node(s) is determined to be more efficient for the request, and to the second storage node(s) when the second storage node(s) is determined to be more efficient for the request; and
receiving the results of the query from the storage node(s) that is determined to be more efficient.

3. The system of claim 1, wherein the copy of data written to each of the storage nodes is the same data.

4. The system of claim 1, wherein the ACID properties are maintained.

5. The method of claim 2, wherein the queries are satisfied from a row-based store or a columnar-store, the row based store including all the data and the column-based store including all or part of the data.

6. The method of claim 5, wherein a query is satisfied by information retrieved from the row based store and the column based store.

7. The method of claim 2, further comprising:
pushing the search request to several storage nodes, said storage nodes searching using a column-organized file,
when data that satisfies the search criteria is found, sending said data to the database node, said database node receiving the data from multiple storage nodes, said query continues to process data using the row based store, said data is returned to the application.

8. The system of claim 1, further comprising one or more user terminal devices that are configured to:
receive user input of a search request;
transmit the search request to one of the database node(s);
receive a result for the search request from the database node that the search request was transmitted to; and
display, on a display screen, information regarding the user input based on the result of the search request.

9. A system comprising:
a shared disk database cluster comprising:
one or more database nodes; and
at least two storage nodes including a first storage node or nodes with data organized in a row-based format, and a second storage node or nodes with data organized in a column-based formant, wherein
each of the storage nodes comprise a memory; and
each of the one or more database nodes comprise a processor configured to:
when a data write operation is received, write a copy of the data to each of the first storage node(s) and the second storage node(s); and
when a data search request is received:
(i) determine whether the first storage node(s) or the second storage node(s) is more appropriate for producing a result for the received data search request based on a query response rate;
(ii) transmit the data search request to the first storage node(s) when the first storage node(s) is determined to be more appropriate for the request, and to the second storage node(s) when the second storage node(s) is determined to be more appropriate for the request; and
(iii) receive the results of the query from the storage node(s) that is determined to be more efficient.

10. The system of claim 1, wherein the determination of whether the first storage node(s) or second storage node(s) are more appropriate is based on comparing previous query response rates.
